(19) United States
(12) Patent Application Publication
(10) Pub. No.: US 2011/0282945 A1
(43) Pub. Date: Nov. 17, 2011

(54) NETWORK AWARE PEER TO PEER

(75) Inventors: Tomas Thyni, Jarfalla (SE); Christian Gotare, Getinge (SE); Johan Kolhi, Vaxholm (SE); Annikki Welin, Solna (SE)

(73) Assignee: Telefonaktiebolaget L M Ericsson (publ), Stockholm (SE)

(21) Appl. No.: 13/146,994

(22) PCT Filed: Feb. 6, 2009
(86) PCT No.: PCT/SE2009/050124

§ 371 Date: Jul. 29, 2011

(51) Int. Cl. G06F 15/16

(52) U.S. Cl. 709/204

(57) ABSTRACT

The present invention relates to a method for selecting suitable peers in a peer to peer network for content downloading whereby identities of peers possessing a specified content are received to a coordinating node. The method comprises steps of fetching network parameters associated with the received identities from a public data base and steps of grouping the peers with respect to the network parameters.

### TECHNICAL FIELD

The present invention relates to methods and arrangements for selecting suitable peers for content downloading, in a peer to peer network.

### BACKGROUND

The increased bandwidth introduced by the penetration of broadband and the availability of enhanced terminal capabilities, content creation and publishing tools has significantly increased in availability on the Internet of user generated content, e.g. YouTube, Podcasting, etc. Software distribution such as Microsoft update, Linux distributions, and content aggregators such as Joost, BBC iPlayer are also becoming established sources of legal online content.

Peer-to-peer technology has shown itself as a viable technology for distributing user generated content and technology of choice of the content aggregators. For example, the iPlayer utilizes an IMP P2P client. Peer-to-peer P2P architecture is a type of network in which each workstation has equivalent capabilities and responsibilities. This differs from client/server architectures where some computers are dedicated to serving the others. The P2P network distributes the computing power between connected peers in the network and utilizes the aggregated resources, e.g. network available bandwidth, for efficient content distribution. P2P is often used as a term to describe one user linking with another user to transfer information and files through the use of a common P2P client to download material, such as software upgrades or media files.

When downloading content using P2P clients, pieces or chunks of the selected file are gathered from several nodes simultaneously in order to decrease download time and to increase robustness of the P2P network. The set of peers to download data chunks from has been selected by a so called Tracker which functions as a gateway between peers in the P2P network. In P2P systems based on Tracker architecture when a client requests content, it contacts the Tracker in order to obtain addresses of peers having the desired data chunks. The Tracker replies with a list of addresses to peers having the data. For example, in the BitTorrent protocol the list of peers in the tracker response is by default 50, if the number of available peers is equal or above 50. If there are more peers that have the desired chunk of content, the tracker randomly selects peers to include in the response, or the tracker may choose to implement a more intelligent mechanism for peer selection when responding to a request. This selection can for example be made based on locality, network measurements and similar. All based on the viewpoint of the Tracker.

The problem is that much locality information and other operator specific information is not usually available to a central Internet based Tracker. Further, the Tracker may not always take the operator needs into account—such as keeping traffic local to the operator at hand.

The limited knowledge of the network location of the different peers causes the traffic flow to be non optimal from a network point of view. This will put unnecessary load on expensive peering connections between Internet Service Providers ISPs, especially when transit peering is used. This also causes longer download times for the end-users.

To overcome this problem there is an initiative called Proactive network Provider Participation for P2P (P4P). The P4P working group has participants from the ISP, Movie/Content, and P2P industries. The working group is focused on helping ISPs handle the demands of large media files and enabling legal distribution using P2P technology, they are building what they believe will be a more effective model of transmitting movies and other large files to customers.

P4P works by having an ISP use an “iTracker” which provides information on how its network is configured. P2P software can query the iTracker and identify preferred data routes and network connections to avoid, or change depending on the time of day. The P2P software can then co-operatively connect to peers which are closer or cheaper for the specific ISP, selectively favoring peers instead of choosing peers randomly, or based on access or sharing speeds.

The drawback with the iTracker; are that the ISP must install an iTracker into there network and the P2P applications must be aware of the ISP specific iTracker and be allowed to connect to it. The P4P iTracker concept is also working against Net Neutrality regulations.

### SUMMARY

An object of the invention to overcome above identified limitations of the prior art. The invention focuses on improving the way of managing P2P traffic in an optimal way from network point of view.

The problem of managing P2P traffic is solved by a method for grouping peers by utilizing public information of the distribution network. The invention describes mechanisms and techniques for selecting peers that possess required content and grouping the peers in a coordinating node, based on network topology. Basically, the method involves grouping of peers based on network information fetched from a public database to the coordinating node.

According to a first exemplary embodiment a tracker receives information of peers that possess requested content. The tracker then collects information with regard to network topology related to the content holding peers, from the public database. The tracker groups the peers with respect to received topology parameters such as for example relative geographical position between peers. After having received a content request from a requesting client, the tracker ranks the grouped peers with respect to for example most favourable location of grouped peers in relation to the requesting client.

In another aspect of the invention, instead of using a tracker as search mechanism, a distributed Hash Table has been used and instead of sending the request from the requesting client to the tracker, the request is forwarded to the most appropriate peer in accordance to the DHT implementation. So, instead of the tracker responding back with the ranked list of IP addresses of peers with the desired content, the found peer that possess the IP addresses, will after having consulted the public database respond back and deliver the ranked list.

An object of the invention is to optimize traffic flow from network point of view without working against Net Neutrality regulations. This object and others are achieved by methods, arrangements, nodes, systems and articles of manufacture.

The invention results in advantages such as it gives the P2P application better knowledge of the network location of the different peers, and by ranking and choosing the download peers based on their peer-to-peer network location it will result in a more optimal traffic flow from a network point of view. This will reduce the P2P applications traffic load on expensive peering and transit connections between ISPs, and try to keep the P2P traffic local to the ISP's network if possible. This will also reduce download times for the end-users.

The invention will now be described more in detail with the aid of preferred embodiments in connection with the enclosed drawings.

### BRIEF DESCRIPTION OF THE DRAWINGS

FIG. 1 is a block schematic illustration disclosing a plurality of clients connected via various access networks to Internet. A central P2P Tracker is located in the internet. The Tracker is associated with a central public database.

FIG. 2 discloses a signal sequence diagram representing a method for grouping and ranking suitable peers and downloading a ranking list to a requesting client, according to a first embodiment.

FIG. 3 discloses the same block schematic illustration as is shown in FIG. 1 disclosing a plurality of clients connected via various access networks to Internet. The figure also discloses a grouping table showing content holding peers grouped in relation to a requesting client.

FIG. 4 discloses a signal sequence diagram that represents a method for grouping peers.

FIG. 5 discloses a block schematic illustration of a coordinating node.

### DETAILED DESCRIPTION

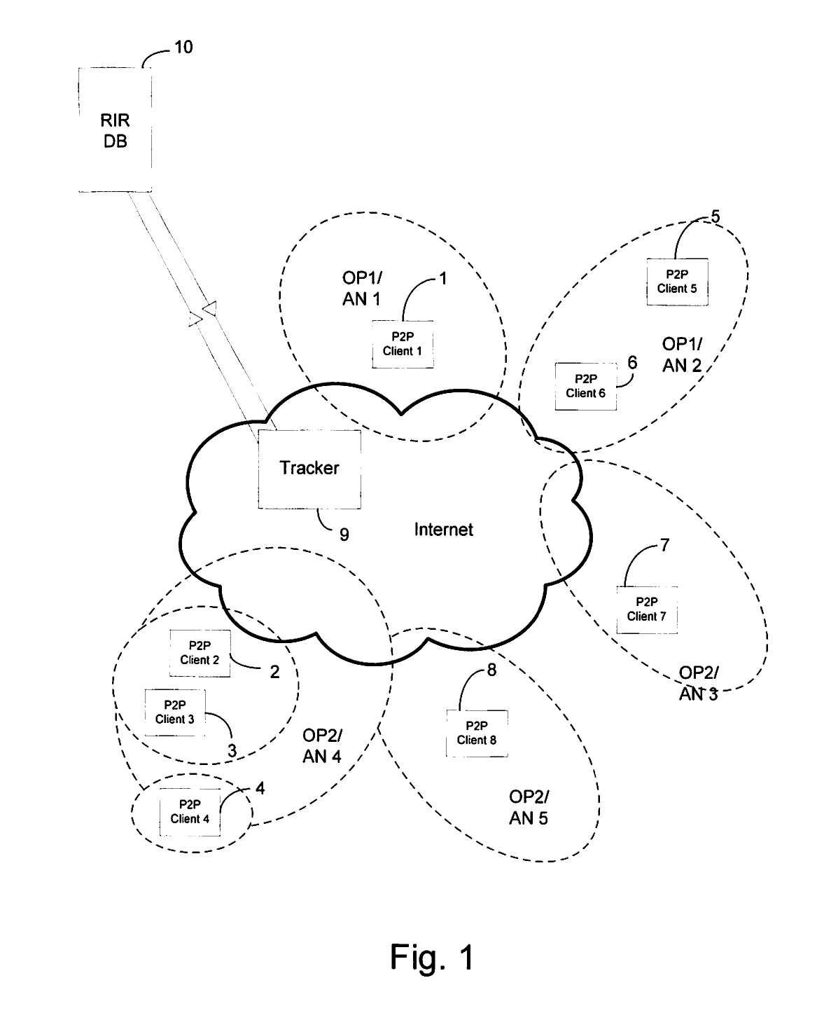

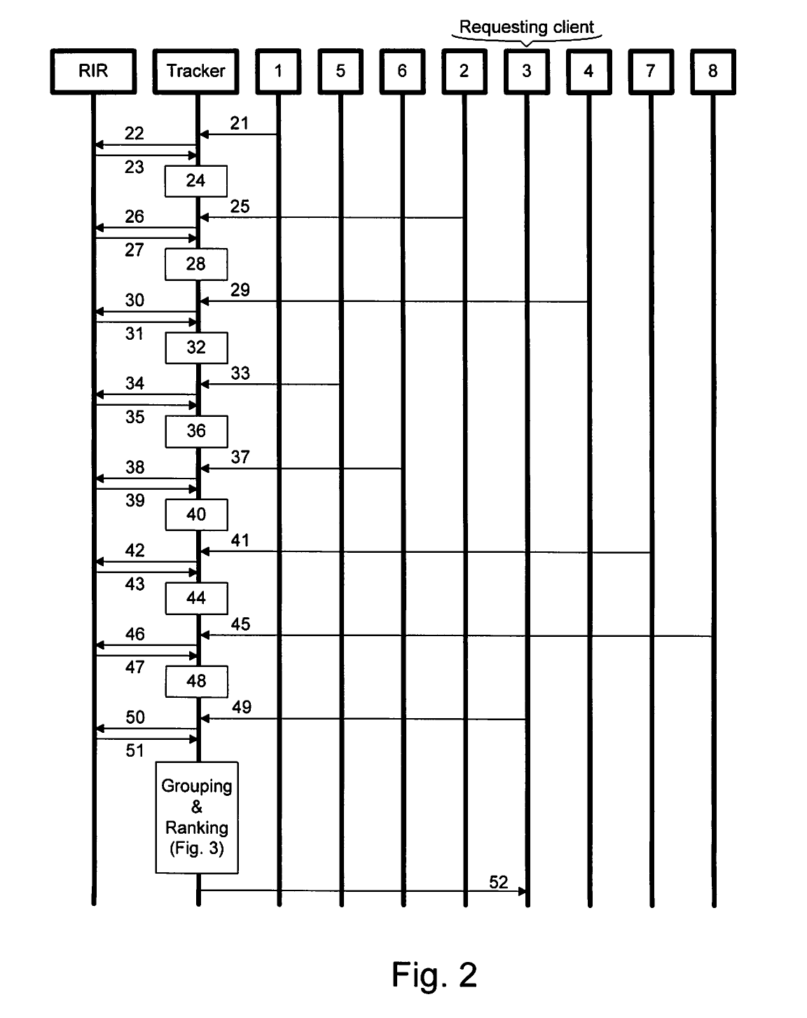

FIG. 1 discloses according to an exemplary embodiment, a peer to peer P2P network that includes plural clients 1-8 connected via various access networks AN1-AN5 to INTERNET. The figure discloses a very simplified example and the number of clients are in the reality much higher. The clients 1-8 may be, for example, a mobile phone, a computer, a set top box, or other devices that are capable of exchanging information with the internet. The access networks AN1-AN5 may be, for example, a communication network, a phone network, an Internet service provider, etc. In this exemplified embodiment a first operator OP1 is accessible in the access networks AN1-AN2 and a second operator OP2 is accessible in AN3-AN5. The client 1 is attached to OP1/AN1, the clients 5 and 6 are attached to OP1/AN2, the clients 2-4 are attached OP2/AN4, client 7 is attached to OP2/AN3 and client 8 is attached to OP2/AN5. A central tracker 9 is in this example located within the Internet. The tracker functions as a directory service for the clients, also called peers, in the P2P network. A P2P tracker may be any P2P searching mechanism (e.g. the BitTorrent tracker system). The tracker gathers information on which peers have what data chunks and spread information to any requesting peer. The central tracker is capable to communicate and fetch information from a public database RIR 10 (see for example “Wikipedia” in general or “http://en.wikipedia.org/wiki/Regional_Internet_Registry”). The public database is in this example a so called Regional Internet Registrie RIR that manage, distribute, and register public Internet Number Resources within their respective regions. A regional Internet registry (RIR) is an organization overseeing the allocation and registration of Internet number resources within a particular region of the world. Resources include IP addresses (both Ipv4 and Ipv6) and autonomous system numbers. RIRs work closely together, and with others, to develop consistent policies and promote best current practice for the Internet. Internet Number Resources (IP addresses and Autonomous System AS Numbers) are distributed in a hierarchical way. RIRs allocate IP address space and AS Numbers to Local Internet Registries that assign these resources to end users. In this first embodiment that will be explained more in detail together with FIG. 2, a method for grouping and ranking suitable peers for content downloading will be shown. According to the first exemplary embodiment, a tracker receives information of peers that possess requested content. The tracker then, according to the invention, collects information related to content holding peers, with regard to network topology, from the public database RIR. Instead of a RIR the Tracker might fetch public information from an Internet Routing Registry IRR (see for example “Wikipedia” or “http://www.irr.net/docs/list.html”). The tracker groups the peers with respect to network parameters such as for example relative geographical position between the peers. After having received a request for the content from a requesting client, the tracker ranks the grouped peers with respect to, for example, most favourable location of grouped peers in relation to the requesting client.

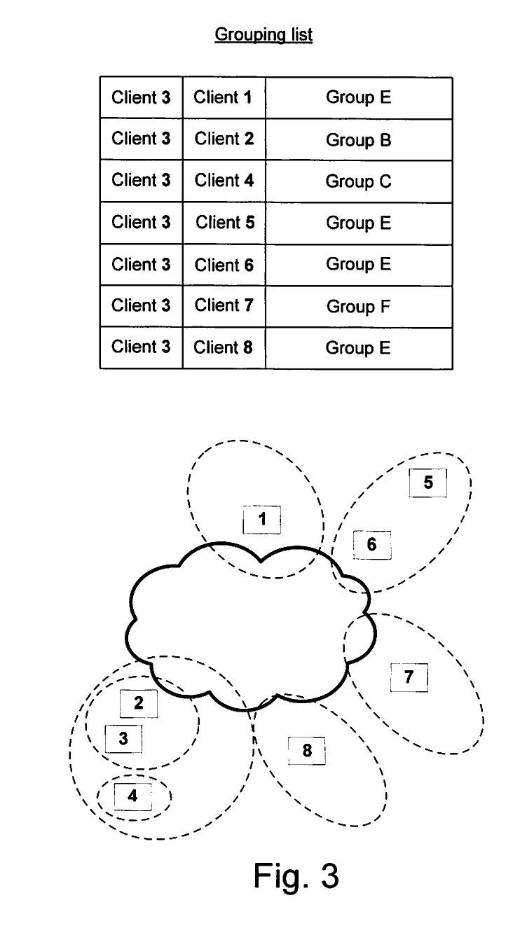

The method according to the first embodiment will now be explained together with FIG. 2. FIG. 2 is a signal sequence diagram wherein the signalling points RIR 10, Tracker 9 and the clients 1-8 that were briefly explained earlier together with FIG. 1 have been disclosed. According to the well known P2P protocol, the Tracker continuously receives torrent files from peers/clients. The Torrent files comprise metadata pointing at peers where pieces of data chunks, from now referred to as the content, can be obtained from or be delivered to. The method comprises the following steps:
A torrent file comprising an identity i.e. an IP address pointing at client 1 is received 21 from client 1 to the Tracker 9. Client 1 hereby informs the tracker that it is willing to download the content.
According to the invention, the Tracker searches a local storage to see if the file pointing at the client 1 already has been cashed in the storage. The storage can be located “within” or “outside” the Tracker.
In this example the file was not cashed since before and the Tracker sends 22 a network parameter requests comprising the IP address pointing at client 1, to the public database RIR. It is to be noted that the Internet Service Provider ISP, Autonomous System AS and routed IP subnet information is not changing that often, and can then be cashed by the tracker. So next time a client connects from the same IP subnet as a previous peer/client, the cached information can be used instead of queering the RIR or IRR database. The mentioned query 22 uses a standard that is interface with RIR specific command options. The query may point out another RIR as the one responsible for managing the information. E.g. a request towards the ARIN RIR (see for example “Wikipedia” or “http://www.arin.net/”) for an IP address in a network in Europe, will point out RIPE as the RIR for handling the information, and this will require a subsequent query towards the RIPE database.
The RIR replies 23 with network parameters associated with the IP address of client 1, from the public database to the Tracker. In case the file pointing at client 1 was cashed in the local storage since before, the steps 22 and 23 of sending and replying would not have been performed.
The tracker cashes 24 the response from the RIR in the local storage and checks according to the invention if an IP address pointing at a peer holding the same content also is cashed in the storage. If that was the case, grouping will start. The grouping will be further explained later in the description.
In the same way as described above, after having received 25 a torrent file comprising an IP address pointing at client 2 that is willing to download content, the Tracker searches a local storage to see if the file pointing at the client 2 already has been cashed in the storage. In this example the file was not cashed and the Tracker sends 26 a network parameter requests comprising the IP address pointing at client 2, to the public database RIR that replies 27 with network parameters associated with the IP address of client 2, from the public database to the Tracker.
The tracker cashes 28 the response from the RIR in the local storage and checks according to the invention if an IP address pointing at a peer holding the same content already is cashed in the storage. The IP address of client 1 is hereby found and grouping of the two content holding peers 1 and 2 now takes place. The grouping will be further clarified later in the description together with FIG. 3A.
In the same way as described above, after having received 29,33,37,41,45 torrent files comprising IP addresses pointing at clients 4,5,6,7,8 (the clients are all willing to download content), the Tracker searches the local storage. In this example the files were not cashed and the Tracker sends 30,34,38,42,46 network parameter requests comprising IP addresses pointing at clients 4,5,6,7,8 to the public database RIR that replies 31,35,39,43,47 with network parameters associated with the IP addresses of the clients.
The tracker cashes 32,36,40,44,48 the responses from the RIR in the local storage and checks if an IP address pointing at a peer holding the same content already was cashed in the storage. In this exemplified embodiment the tracker has received and cashed information from the clients 1,2,4-8, which clients all possess pieces of data chunks that constitutes a subset of the content. Grouping of the peers has continuously been performed after network parameters associated with the IP addresses of clients was cashed in the local storage. The grouping has been performed according to predefined rules. The rule that has been applied in this embodiment can be seen later in the description.

The client 3, from now on referred to as the requesting client, decides to send a request for the content to the Tracker. A prerequisite is that the requesting client 3 by some means know the address of a tracker which has information about which peers that possess the desired content for example by downloading a torrent file such as BitTorrent.
A torrent file comprising an IP address pointing at the requesting client 3 is received 49 from client 3 to the Tracker. Client 3 hereby informs the tracker of it's desire to obtain the content from the P2P network. Like before, the Tracker searches the local storage to see if the file pointing at the client 3 already was cashed in the storage.
Since the file was not cashed in this example, the Tracker sends 50 a network parameter requests comprising the IP address pointing at client 3, to the public database RIR. The RIR replies 51 with network parameters associated with the IP address of client 3, from the public database to the Tracker.
The tracker cashes the response from the RIR in the local storage and starts to group the cashed addresses that belong to the clients 1,2,4-8 together with the newly received address of the requesting client 3. This final grouping of content holding clients together with the requesting client is disclosed in FIG. 2 with a block symbol and will now be further explained together with FIG. 3.

FIG. 3 discloses the same network configuration as was disclosed in FIG. 1. The figure also discloses a table showing the final grouping performed after having received the request for content from the requesting client 3. The grouping has been done according to the below shown ranking scheme. To be noted is that the scheme in this example is based on currently available operator preferences and is just an example. Another parameter that can be considered for the ranking is for example operator possession. The network ranking can also be used together with common P2P client information like access line bandwidth and maximum up-load speed, to get the best peer-to-peer relationship ranking etc.

Below is the mentioned ranking scheme following rules from a geographical network location point of view that has been applied in this embodiment:
A. Extremely Good, Within a /22 address range in the ISP assigned IP-subnet
B. Very Good, Within ISP assigned IP-subnet
C. Good, Different IP-subnet within the same ISP's AS number
D. Fairly Good, IP-subnet in an different AS, but within the same ISP
E. Fair, Direct peering between different ISP's AS
F. Very Bad, Transit Peering via multiple AS hops

As can be seen in the table in FIG. 3, peer 3 has been ranked in relation with peer 2 as a group B relation, i.e. “Very good, Within ISP assigned IP-subnet”. Peer 3 has been ranked in relation with peer 4 as a group C relation, i.e. “Good” and in relation with peers 1,5,6,8 as a group E relation i.e. “Fair”, while in relation to peer 7, peer 3 has been ranked as a group F relation i.e. “Very bad”. The tracker creates a ranking list regarding the requesting client's most favourable peers to download content from, with the most favourable peer at the top of the list. The created ranking list in this example looks like follows:
1. Client 2
2. Client 4
3. Clients 1,5,6,8
4. Client 7

When the ranking list is finalized in the Tracker, the tracker sends 52 the ranking list to the requesting client 3. This can be seen in FIG. 2. The requesting client now decides which peers to download content from by using the ranking list as reference, and contacts the chosen content holding peers and starts to download the content according to well known conventional P2P technique.

If the client was unable to establish a connection to top ranked peers from the list for example if the peer has left the P2P network, or if the aggregated download speed from the selected peers is too low, the requesting client could either select lower ranked peers or request a further list of ranked peers from the Tracker.

A second embodiment of the invention will now briefly be discussed. Instead of using a tracker as search mechanism, a Distributed Hash Table may be used. One of the central parts of a P2P system is a directory service. Basically the directory service is a database which contains IP addresses of peers that have a specific content. In a centralized P2P implementation this directory is called tracker (as discussed above), in a distributed P2P implementation it is called Distributed Hash Table DHT. In DHT a plurality of distributed databases resides on many peers rather than in a single node like in the tracker case; hence it is a distributed database. The DHT algorithm is well known by persons skilled in the art. In this second embodiment instead of sending the request from the requesting client to the tracker, the request is forwarded to the most appropriate peer in accordance to the DHT implementation. So, instead of the tracker responding back with the ranked list of IP addresses of peers with the desired content, the found peer—also called a coordinating node, that possess the IP addresses, will after having consulted the public database RIR respond back and deliver the ranked list (For more information of “trackerless” torrent see e.g. “http://www.bittorrent.org/beps/bep 0005.html”). As an alternative a DHT based tracker can exist in carrier domain that contains several servers, then the solution is more stable.

The invention can also be used in server to client communication when the same content should be distributed to many clients, with the option to use Unicast or Multicast distribution depending on multiple clients' network location.

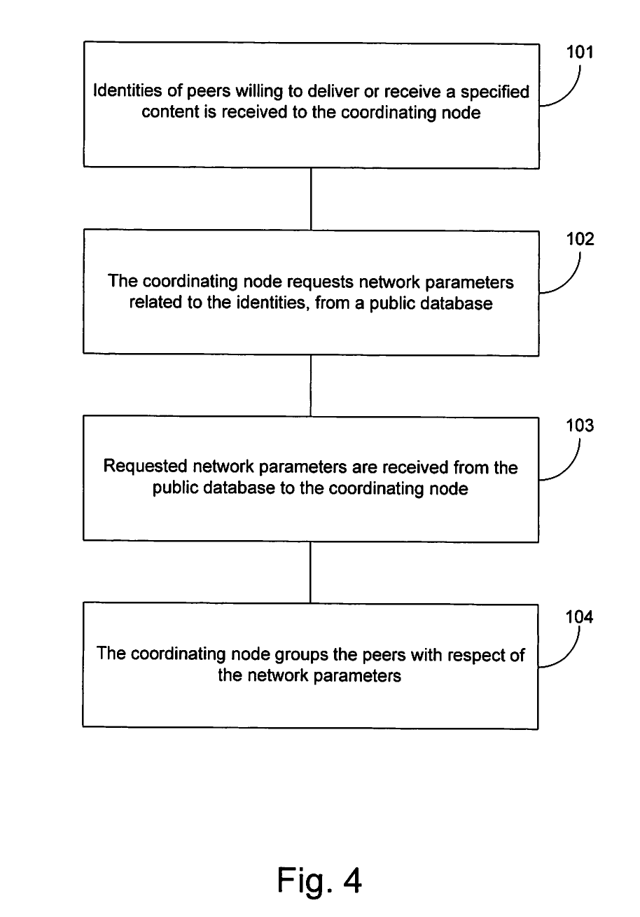

FIG. 4 discloses a flow chart illustrating some essential method steps of the invention. The flow chart is to be read together with the earlier shown figures. The flow chart comprises the following steps:
identities of peers willing to deliver/receive content is received to the coordinating node. This step is shown in the figure with a block 101.
If not already cached, the coordinating node requests network parameters related to the received identities, from a public database. This step is shown in the figure with a block 102.
The coordinating node receives network parameters related to the identities, from the public database. This step is shown in the figure with a block 103.
The coordinating node groups the peers from a network point of view. This step is shown in the figure with a block 104.

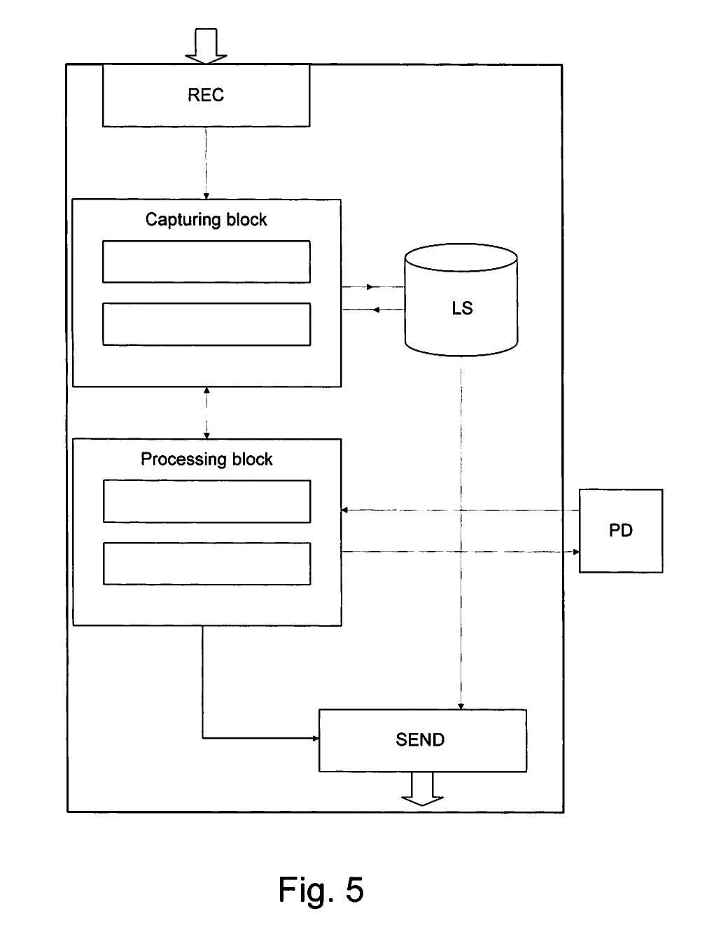

FIG. 5 discloses in some more detail an example of the coordinating node 9 that has been discussed earlier in the application together with the previous FIGS. 1-3. In the previous figures the coordinating node has been represented by for example the tracker.

This section describes as an example some for the invention important parts of the coordinating node. As can be seen in FIG. 5, the coordinating node comprises two main blocks i.e. a capturing block and a processing block. Data files from content holding peers (or peers that desire to receive content) are received to a receiver REC and forwarded to the capturing block.

The capturing block is responsible for extracting the identities for peers from the data files and to query the local data base LS to see if a peer already has been cashed in the database.

The processing block is responsible for the requesting of network parameters associated with IP addresses extracted from the messages in the capturing block; from a public database PD. The processing block also receives the network parameters from the public database. The processing block is also responsible for the earlier discussed grouping and ranking of peers by querying the local data base LS. A created ranking list is forwarded from the coordinating node to a requesting peer via a sender SEND.

A system that can be used to put the invention into practice is schematically shown in the FIG. 1 and FIG. 5. Enumerated items are shown in the figures as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The systems and methods of the present invention may be implemented for example on any of the Third Generation Partnership Project (3GPP), European Telecommunications Standards Institute (ETSI), American National Standards Institute (ANSI) or other standard telecommunication network architecture. Other examples are the Institute of Electrical and Electronics Engineers (IEEE) or The Internet Engineering Task Force (IETF).

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. The invention is not limited to the above described and in the drawings shown embodiments but can be modified within the scope of the enclosed claims.

1. A Method for selecting peers suitable for content downloading in a peer to peer network, wherein identities of peers possessing a specified content are received by a coordinating node, comprising:
fetching network parameters associated with the received identities; and
grouping the peers with respect to the network parameters.

2. The method for selecting suitable peers according to claim 1, wherein the fetching step comprises:
sending, from the coordinating node and to a public database, a network parameter request comprising an IP address identity of a peer;
receiving, at the coordinating node, network parameters associated with the IP address sent from the public database to the coordinating node.

3. The method for selecting suitable peers according to claim 1, wherein the fetching step comprises:
checking if a network parameter related to an IP address identity of a peer is cached in a storage (LS).

4. The method for selecting suitable peers according to claim 1, wherein the grouping step comprises:
checking if a content corresponding peer is cashed;
grouping peer-to-peer relationship with regard to network parameters.

5. The method for selecting suitable peers according to claim 1, wherein a requesting client requests the specified content and whereby grouped peers are ranked with respect to network parameters of the requesting client versus parameters of the grouped peers.

6. The method for selecting suitable peers according to claim 5, wherein a list of ranked peers is sent from the coordinating node to the requesting client.

7. The method for selecting suitable peers according to claim 1, wherein the public database manages, distributes and/or registers public internet number resources within their respective regions.

8. The method for selecting suitable peers according to claim 1, wherein each group contains peers related to each other by a specific criterion.

9. The method for selecting suitable peers according to claim 8, wherein the criterion is based on at least one of the following rules:
geographical network location;
operator possession;
access line bandwidth;
up-load speed.

10. A node for selecting peers suitable for content downloading in a peer to peer network, wherein identities of peers possessing a specified content are received by the node, and the node is adapted to fetch network parameters associated with the received identities and group the peers with respect to the network parameters.

11. The node for selecting suitable peers according to claim 10, wherein the node comprises:
a transmitter for sending a network parameter request comprising an IP address identity of a peer to a public database; and
a receiver for receiving network parameters associated with the IP address from the public database.

12. The node for selecting suitable peers according to claim 10, wherein the node is further adapted to determine whether:
a network parameter related to an IP address identity of a peer is cached in a storage (LS).

13. The node for selecting suitable peers according to claim 10, wherein the node is further adapted to
determine whether a content corresponding peer is cached; and
group peer-to-peer relationship with regard to network parameters.

14. The node for selecting suitable peers according to claim 10, wherein the node is further adapted to rank grouped peers with respect to network parameters of a requesting client versus parameters of the grouped peers.

15. The node for selecting suitable peers according to claim 14, wherein the node is further adapted to send a list of ranked peers from the node to the requesting client.

16. The node for selecting suitable peers according to claim 10, wherein the node is a tracker.

17. The node for selecting suitable peers according to claim 16, wherein the tracker is a decentralized tracker.

18. An Article of manufacture comprising a program storage medium having a computer readable code embodied therein to select suitable peers in a peer to peer network for content downloading, the program code comprising:
computer readable program code for receiving identities of peers possessing a specified content;
computer readable program code for fetching network parameters associated with the received identities;
computer readable program code for grouping the peers with respect to the network parameters.

19. A network operator system for content downloading from suitable peers in a peer to peer network, the system being adapted to:
receive identities of peers possessing a specified content;
send to a public database a network parameter request comprising an IP address identity of a peer;
receive network parameters associated with the IP address from the public database; and
group the peers with respect to the network parameters.
